(19) United States
(12) Patent Application Publication
(10) Pub. No.: US 2011/0003934 A1
(43) Pub. Date: Jan. 6, 2011

(54) PREPARATION OF WATERPROOF BREATHING PU FILM

(76) Inventor: MENG-THENG WANG, Chenghe City (TW)

Correspondence Address: LEONG C. LEI, PMB # 1008, 1839 YGNACIO VALLEY ROAD, WALNUT CREEK, CA, 94598, US

(21) Appl. No.: 12/497,556

(22) Filed: Jul. 3, 2009

(51) Int. Cl. C08G 18/82

(52) U.S. Cl. 524/589

(57) ABSTRACT

A waterproof breathing PU film preparation method include the steps of (a) processing polyurethane polymers into a polyurethane colloid, (b) mixing the polyurethane colloid with a cationic water repellent and a cationic bridging agent at a ratio that the cationic water repellent and the cationic bridging agent take about 1%˜10% and the polyurethane colloid takes about 900%˜99% to provide a polyurethane mixture, and (c) using the polyurethane mixture to make a waterproof breathing PU film having a thickness ≧0.01 mm.

### BACKGROUND OF THE INVENTION

(a) Technical Field of the Invention The present invention relates to plastic film fabrication technology and more particularly, to the preparation of a waterproof breathing PU film.

(b) Description of the Prior Art

A polyurethane (PU) is any polymer consisting of a chain of organic units joined by urethane (carbamate) links. Polyurethanes are widely used in high resiliency flexible foam seating, rigid foam insulation panels, durable elastomeric wheels and tires, seals, gaskets, carpet underlay, and hard plastic parts. However, regular polyurethane products are not air permeable. When adding a foaming agent to a polyurethane material for making breathing polyurethane products, the breathing pores in the breathing polyurethane products thus made have a certain diameter not capable of stopping leakage of water. Thus, breathing polyurethane products are not waterproof.

### SUMMARY OF THE INVENTION

The primary purpose of the present invention is to provide a waterproof polyurethane film that breathes.

To achieve this and other objects of the present invention, a waterproof breathing PU film preparation method is to make a waterproof breathing PU film by means of processing polyurethane polymers into a dispersed, colloid-like or solution-like material that contains anions, and then adding a cationic water repellent and a cationic bridging agent to the material thus, for enabling cations to attract anions so that the polymer bonding molecules are caused to escape for allowing pass of air molecules but prohibiting passing of water molecules. Further, the finished waterproof breathing PU film has a thickness ≧0.01 mm capable of resisting water pressure.

The technical measure of the present invention is to process polyurethane polymers into a polyurethane colloid, and then to mix the polyurethane colloid with a cationic water repellent and a cationic bridging agent at a ratio that the cationic water repellent and the cationic bridging agent take about 1%˜10% and the polyurethane colloid takes about 90%˜99%. The polyurethane mixture thus obtained is used to make a waterproof breathing PU film having a thickness ≧0.01 mm.

Further, polyurethane polymers can be processed into PU grains and then melted at temperature over 100° C., thereby forming the desired polyurethane colloid.

Alternatively, polyurethane polymers can be processed into a PU solvent paste and then diluted with glycol ether solvent to form the desired polyurethane colloid.

Alternatively, polyurethane polymers can be processed into a PU water soluble dispersant and then mixed with a thickening agent and a hardening agent to form the desired polyurethane colloid.

Further, the prepared polyurethane colloid can be mixed with the cationic water repellent and the cationic bridging agent at room temperature or under a heating temperature within 100° C.

Further, the polyurethane colloid is reclaimable (if defective) for processing into PU grains, PU solvent paste or PU water soluble dispersant for making a waterproof breathing PU film.

Further, a waterproof breathing PU film made according to the present invention can be used for making medical patches, baby diapers, adult diapers, female sanitary pads, linings for waterproof breathing coat and raincoat, etc.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a flow chart showing a waterproof breathing PU film preparation method in accordance with a first embodiment of the present invention.

FIG. 2 is a flow chart showing an alternate form of the waterproof breathing PU film preparation method in accordance with a second embodiment of the present invention.

FIG. 3 is a flow chart showing an alternate form of the waterproof breathing PU film preparation method in accordance with a third embodiment of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

A waterproof breathing PU film preparation method in accordance with a first embodiment of the present invention comprises the steps of:

(a) processing polyurethane polymers into a polyurethane colloid;

(b) mixing the polyurethane colloid with a cationic water repellent and a cationic bridging agent at a ratio that the cationic water repellent and the cationic bridging agent take about 1%˜10% and the polyurethane colloid takes about 90%˜99% to provide a polyurethane mixture; and

(c) using the polyurethane mixture to make a waterproof breathing PU film having a thickness ≧0.01 mm.

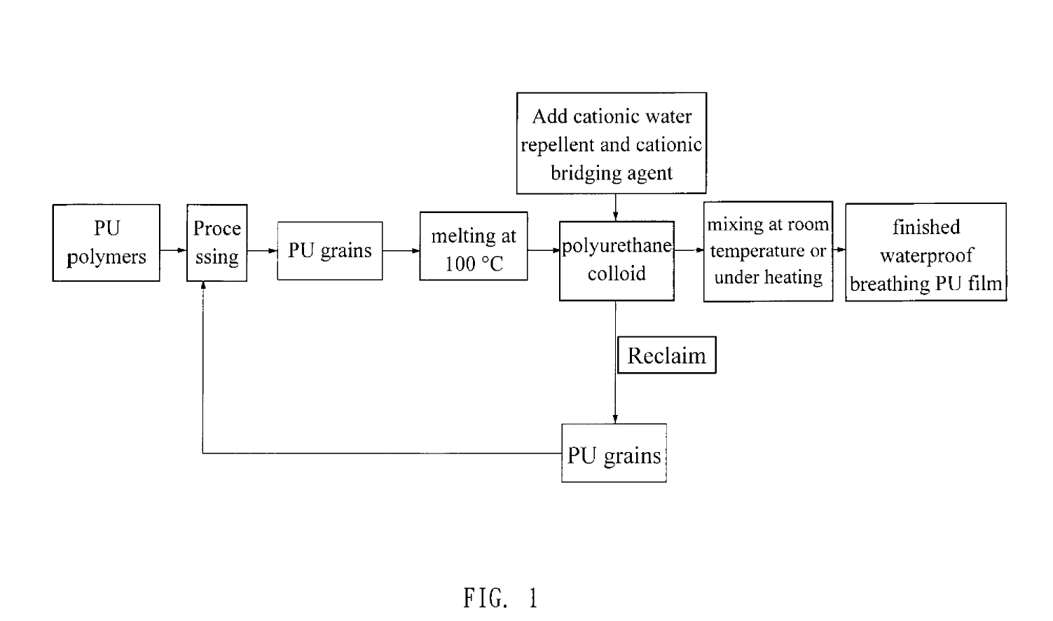

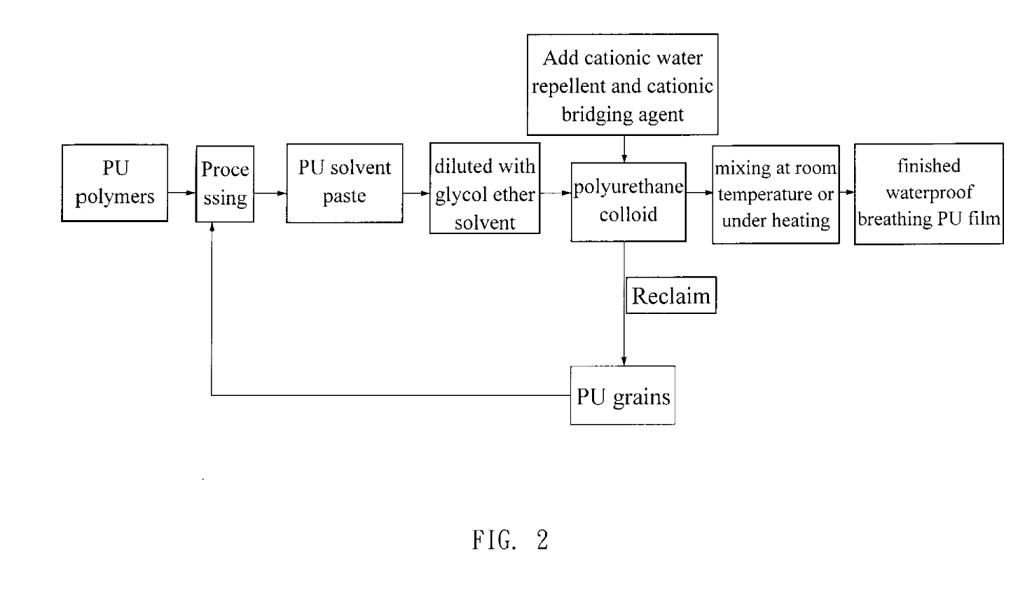

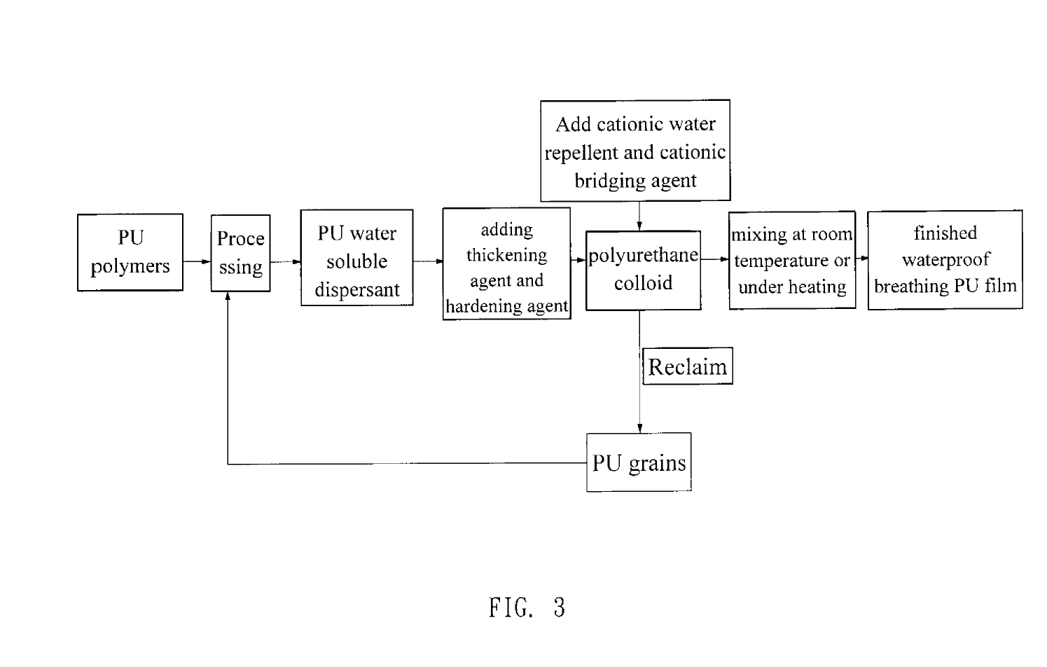

As shown in FIG. 1, during step (a), polyurethane polymers can be processed into PU grains and then melted at temperature over 100° C., thereby forming a polyurethane colloid. Alternatively, as shown in FIG. 2, polyurethane polymers can be processed into a PU solvent paste and then diluted with glycol ether solvent to form a polyurethane colloid. Alternatively, as shown in FIG. 3, polyurethane polymers can be processed into a PU water soluble dispersant and then mixed with a thickening agent and a hardening agent to form a polyurethane colloid. The viscosity of the polyurethane colloid is controlled within 1000˜30000P.

During step (b), the polyurethane colloid is well mixed with cationic water repellent and cationic bridging agent at room temperature or under a heating temperature within 100° C.

The aforesaid cationic water repellent can be cationic silicon water repellent or cationic fluoride water repellent; the cationic bridging agent can be cationic silicon bridging agent or cationic fluoride bridging agent.

When polyurethane polymers are decomposed into dispersed, colloid-like or solution status, the material contains anions. Therefore, adding a cationic water repellent and a cationic bridging agent to the prepared polyurethane colloid, anions and cations attract each other. Attraction between the anions and the cations causes polymer bonding molecules to escape, for allowing pass of air molecules but prohibiting passing of water molecules. Further, the finished waterproof breathing PU film has a thickness ≧=0.01 mm capable of resisting water pressure. Further, except breathing characteristic, a waterproof breathing PU film made according to the present invention is elastic. Therefore, when a waterproof breathing PU film prepared according to the present invention receives a water pressure, the polyurethane colloid will be forced to compress pores therein, enhancing the waterproof function of the waterproof breathing PU film.

Further, the polyurethane colloid is reclaimable (if defective) for processing into PU grains, PU solvent paste or PU water soluble dispersant for making a waterproof breathing PU film.

Further, a waterproof breathing PU film made according to the present invention can be used for making medical patches, baby diapers, adult diapers, female sanitary pads, linings for waterproof breathing coat and raincoat, etc.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A waterproof breathing PU film preparation method, comprising the steps of:
(a) processing polyurethane polymers into a polyurethane colloid;
(b) mixing said polyurethane colloid with a cationic water repellent and a cationic bridging agent at a ratio that said cationic water repellent and said cationic bridging agent take about 1%˜10% and said polyurethane colloid takes about 90%˜99% to provide a polyurethane mixture; and
(c) using said polyurethane mixture to make a waterproof breathing PU film having a thickness ≧0.01 mm.

2. The waterproof breathing PU film preparation method as claimed in claim 1, wherein during the step (a), polyurethane polymers are processed into PU grains and then heated at temperature over 100° C., thereby forming said polyurethane colloid.

3. The waterproof breathing PU film preparation method as claimed in claim 1, wherein during the step (a), polyurethane polymers are processed into a PU solvent paste and then diluted with glycol ether solvent to form said polyurethane colloid.

4. The waterproof breathing PU film preparation method as claimed in claim 1, wherein during the step (a), polyurethane polymers are processed into a PU water soluble dispersant and then mixed with a thickening agent and a hardening agent to form said polyurethane colloid.

5. The waterproof breathing PU film preparation method as claimed in claim 1, wherein during the step (b), said polyurethane colloid is mixed with said cationic water repellent and said cationic bridging agent at room temperature.

6. The waterproof breathing PU film preparation method as claimed in claim 1, wherein during the step (b), said polyurethane colloid is mixed with said cationic water repellent and said cationic bridging agent under a heating temperature within 100° C.
